(19) United States
(12) Patent Application Publication
(10) Pub. No.: US 2025/0354420 A1
(43) Pub. Date: Nov. 20, 2025

(54) HOUSEHOLD APPLIANCE

(71) Applicant: WHIRLPOOL CORPORATION, BENTON HARBOR, MI (US)

(72) Inventor: MARCO GRANDI, VARESE (IT)

(21) Appl. No.: 18/667,110

(22) Filed: May 17, 2024

(51) Int. Cl. E05D 3/18; E05D 7/081

(52) U.S. Cl. CPC E05D 3/18; E05D 7/081; E05Y 2900/308

(57) ABSTRACT

A household appliance includes a chassis defining a treating chamber and further includes an access opening for access to the treating chamber. The household appliance includes a closure element for selectively closing the access opening having at least one hinge assembly moveably coupled to the closure element and the chassis for pivotable motion between an opened position and a closed position. The at least one hinge assembly includes a first plate mounted to one of the chassis or the closure element and a second plate mounted to the other of the chassis or the closure element. The first plate having a first pin and an arcuate aperture spaced from and having an edge with a consistent distance from the first pin.

### TECHNICAL FIELD

The description generally relates to household appliances, and more specifically a household appliance with a hinge assembly.

### BACKGROUND

Household appliances, such as microwave ovens, conventional ovens, and washing machines, typically have a hinged closure element that opens and closes relative to an access opening.

### BRIEF DESCRIPTION

In one aspect, the disclosure relates to a household appliance comprising: a chassis having an access opening; a treating chamber accessible via the access opening; a closure element selectively moveable to close the access opening; and at least one hinge assembly moveably coupling the closure element to the chassis for pivotable motion between an opened position and a closed position where the closure element closes the access opening, the at least one hinge assembly comprising: a first plate mounted to one of the chassis or the closure element, the first plate comprising a first pin and an arcuate aperture spaced from and having an edge with a consistent distance from the first pin; a second plate mounted to the other chassis or the closure element, the second plate having a circular aperture configured to receive the first pin such that the first pin defines an axis of rotation for the at least one hinge assembly, the second plate having a second pin configured to be received within the arcuate aperture and configured for movement along at least a portion of the length of the arcuate aperture during pivotable motion between the opened position and the closed position.

In another aspect, the disclosure relates to a household appliance comprising: a chassis having an access opening; a treating chamber accessible via the access opening; a closure element selectively moveable to close the access opening; and at least one hinge assembly moveably coupling the closure element to the chassis for pivotable motion between an opened position and a closed position where the closure element closes the access opening, the at least one hinge assembly comprising: a first plate mounted to one of the chassis or the closure element, the first plate comprising a first pin and an arcuate aperture defining a circular arc cut-out that has a non-uniform diameter throughout the arc, more particularly larger at an intermediate portion and narrower at the end portions; a second plate mounted to the other chassis or the closure element, the second plate having a circular aperture configured to receive the first pin such that the first pin defines an axis of rotation for the at least one hinge assembly, the second plate having a second pin configured to be received within the arcuate aperture and configured for movement along at least a portion of the length of the arcuate aperture during pivotable motion between the opened position and the closed position.

### BRIEF DESCRIPTION OF THE DRAWINGS

In the drawings:

FIG. 1 is a perspective view of a built-in appliance with a closure element in an opened position.

FIG. 2 is a perspective view of a door of the built-in appliance of FIG. 1, the door removed from a chassis with a first hinge assembly and a second hinge assembly in the opened position.

FIG. 3 is the second hinge assembly of FIG. 2 with the door removed.

FIG. 4 is an exploded view of the second hinge assembly of FIG. 3.

FIG. 5 is an enlarged top perspective view of a portion of the first hinge assembly and a portion of the second hinge assembly of the built-in appliance of FIG. 1.

### DETAILED DESCRIPTION

Features, advantages, and aspects of the present disclosure are set forth or apparent from a consideration of the following detailed description, drawings, and claims. Moreover, the following detailed description is exemplary and intended to provide explanation without limiting the scope of the disclosure as claimed.

As used herein, the terms “first,” “second,” or the like can be used interchangeably to distinguish one component from another and are not intended to signify location or importance of the individual components. In addition, the singular forms “a,” “an,” and “the” include plural references unless the context clearly dictates otherwise.

Additionally, as used herein, a “controller” or “controller module” can include a component configured or adapted to provide instruction, control, operation, or any form of communication for operable components to effect the operation thereof. A controller module can include any known processor, microcontroller, or logic device, including, but not limited to: field programmable gate arrays (FPGA), an application specific integrated circuit (ASIC), a proportional controller (P), a proportional integral controller (PI), a proportional derivative controller (PD), a proportional integral derivative controller (PID controller), a hardware-accelerated logic controller (e.g. for encoding, decoding, transcoding, etc.), or the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

All directional references (e.g., top, bottom, vertical, horizontal, etc.) are only used for identification purposes to aid the reader's understanding of the present disclosure, and do not create limitations, particularly as to the position, orientation, or use of aspects of the disclosure described herein. Connection references (e.g., attached, coupled, fastened, and connected) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

Household appliances can include one or more hinge assemblies for pivoting a closure element, selectively allowing access to a treating chamber. Such hinge assemblies can include a first hinge plate mounted to a closure element, and a second hinge plate fixedly mounted on a chassis of the household appliance, where the first hinge plate pivotally mounts to the second hinge plate via one or more pins, and one or more apertures that receive such pins.

In some instances, interactions between the one or more pins and the one or more apertures can generate a non-fluid or non-smooth movement of the closure element due to misalignment of the one or more pins within the one or more apertures. The misalignment of the pins received in the apertures is caused by shape of or dimensioning of cuts and tolerances of cuts due to manufacturing variability. Thus, it would be beneficial to include a hinge assembly where the dimensioning of the one or more pins and the cut or shape of the one or more apertures is optimized to allow the alignment of the one or more pins in the one or more apertures, allowing for a smooth and precise movement of the closure element.

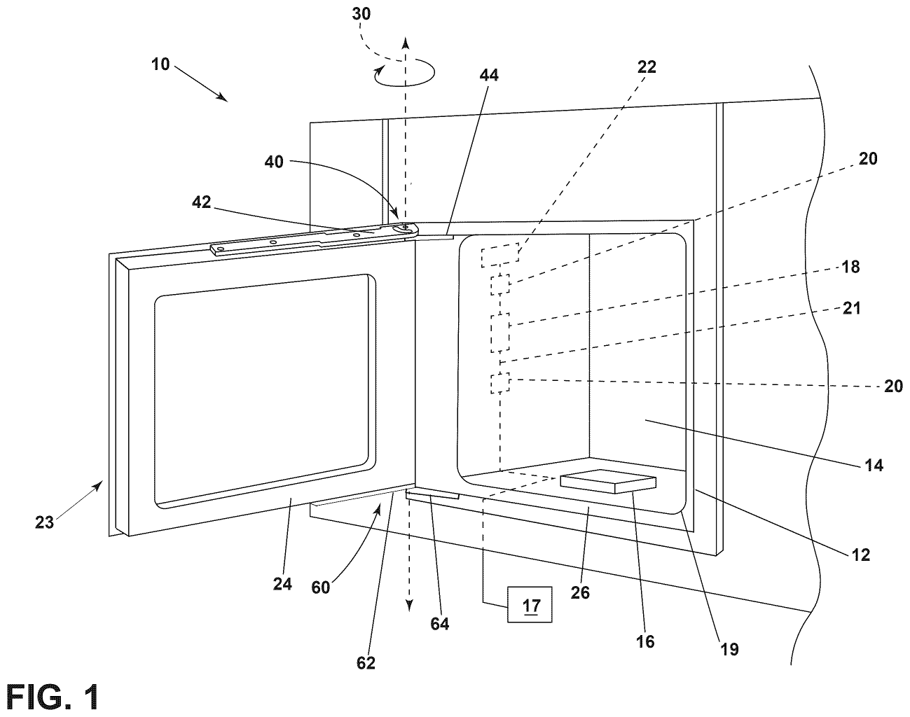

Turning to FIG. 1, an exemplary household appliance is shown in the form of a built-in microwave appliance or microwave oven 10. The microwave oven 10 includes a chassis 12 defining a treating chamber shown in the form of a cooking chamber 14. The cooking chamber 14 can receive at least one food item 16. In particular, the chassis 12 can include an access opening 19 providing access to the cooking chamber 14, through which the at least one food item 16 can be placed in the cooking chamber 14 or removed from the cooking chamber 14.

The microwave oven 10 includes a closure element, where the closure element can include a panel, a lid, or, as illustrated herein, a door 23, selectively closing the access opening 19.

The door 23 includes at least one hinge assembly illustrated, by way of example as a first hinge assembly 40 and a second hinge assembly 60. The first hinge assembly 40 and the second hinge assembly 60 moveably couple the door 23 to the chassis 12 for pivotable motion between an opened position, as illustrated, and a closed position (not shown). The pivotable motion of the door 23 can be about a vertical axis of rotation 30 defined by the first hinge assembly 40 and the second hinge assembly 60. That is, the door 23 pivots about the vertical axis of rotation 30 between the opened position and the closed position.

The door 23 has an inside surface 24 and the chassis 12 has an access surface 26. The door 23 is in the closed position when a portion of the inside surface 24 of the door 23 is in contact with the access surface 26 of the chassis 12. In other words, the door 23 is in the closed position when the door 23 blocks, prevents access, or otherwise closes the access opening 19.

The first hinge assembly 40 is axially spaced from the second hinge assembly 60 along an edge of the door 23. The door 23 typically includes four edges, where the first hinge assembly 40 and the second hinge assembly 60 are on the same edge, but spaced such that first hinge assembly 40 does not contact the second hinge assembly 60. In the illustrated example, the first hinge assembly 40 and the second hinge assembly 60 are on opposite ends of the door 23 along a rear edge. More specifically, the first hinge assembly 40 is located at a top of the door 23 and the second hinge assembly 60 is located at a bottom of the door 23.

The first hinge assembly 40 includes a first plate 42 and a second plate 44, different from the first plate 42. The first plate 42 is illustrated as coupled or mounted to the door 23, while the second plate 44 is illustrated as coupled or mounted to the chassis 12. However, it is contemplated, in a different and non-limiting example, that the first plate 42 can be mounted to the chassis 12 and the second plate 44 is mounted to the door 23. In other words, the first plate 42 is attached to one of the door 23 or the chassis 12, while the second plate 44 is attached to the other of the door 23 or the chassis 12.

Similarly, the second hinge assembly 60 includes a first plate 62 mounted to the door 23 and a second plate 64 mounted to the chassis 12. However, it is contemplated that the first plate 62 can be coupled to one of the door 23 or the chassis 12, while the second plate 64 is attached to the other of the door 23 or the chassis 12.

As illustrated, by way of non-limiting example, during pivoting motion of the door 23 between the opened position and the closed position, the first plate 42 of the first hinge assembly 40 and first plate 62 of the second hinge assembly 60 pivot with the door 23 about the vertical axis of rotation 30, while the second plate 44 of the first hinge assembly 40 and the second plate 64 of the second hinge assembly 60 are fixed to the chassis 12 and thus stationary. That is, the plate mounted to the door 23 will rotate with the door 23, while the other plate mounted to the chassis 12 remains stationary with the chassis 12.

The microwave oven 10 can be electrically coupled to a power source 17. The power source 17 can include a household power source in some examples, such as an electrical outlet.

At least one heating element, illustrated as at least one microwave generator 18, can be included in the microwave oven 10. The microwave generator 18 can also include other elements, including at least one antenna adapted to provide microwave radiation generated by the microwave generator 18. Such microwave radiation is fed into the cooking chamber 14 by way of at least one feeding port 20 electrically coupled with the microwave generator 18 by a conductor or transmission line 21. As shown, the microwave oven 10 includes a single microwave generator 18 although any number can be provided, including two or more. In some exemplary implementations, where multiple microwave generators 18 are provided, such multiple microwave generators 18 can operate independently with respective outputs, or as a group with a common power output, or in any suitable fashion to collectively provide microwave radiation utilized to heat or cook the food item 16 in the cooking chamber 14.

By way of non-limiting example, cooking appliances can include one or more types of heating elements. That is, the heating elements can include convection heating elements, induction heating elements, steam heating elements, electric or radiant heating elements, gas or flame heating elements, microwave heating elements, or any combination thereof. It is further contemplated that this description is applicable to other household appliances with heating elements such as, but not limited to, washing machines, having electric heating elements.

The microwave oven 10 can also include a controller 22 (also referred to as a controller module), which can be communicatively coupled with any or all of the power source 17, or the microwave generator 18. In the non-limiting example shown, the controller 22 is communicatively coupled to each of the power source 17, and the microwave generator 18 by communication lines. The controller 22 can be configured to control generation of microwave radiation by the microwave generator 18. For example, the controller 22 can operably control the power output provided by the power source 17, the operation of the microwave generator 18, or electromagnetic characteristics of the generated microwave radiation, such as a power level, frequency, phase, or the like.

During a cycle of operation, illustrated as cooking or heating operations, the controller 22 of the microwave oven 10 operates to control the generation of the microwave radiation by the microwave generator 18 and to provide the microwave radiation into the cooking chamber 14 by way of the feeding ports 20. The microwave radiation interacts with the food item 16 to heat or cook the food item 16. The interaction that heats the food item 16, most commonly, is the microwave radiation that cause water molecules in food item 16 to vibrate, producing heat that cooks the food item 16.

It is contemplated that the description herein is applicable to other cooking appliances having pivotable or hinged closure elements. By way of non-limiting example, cooking appliances can be configured for a built-in installation (also referred to herein as “built-in”) or stand-alone configurations. That is, a built-in installation can be defined as the integration of the cooking appliance into cabinetry or walls. Further, cooking appliances can include a built-in or standalone conventional oven, a built-in or stand-alone convection oven, or a variety of microwave implementations such as, but not limited to, stand-alone or drawer-type microwaves. It is further contemplated that this description is applicable to other household appliances with pivoting doors or lids such as, but not limited to, washing machines, having pivotable closure elements.

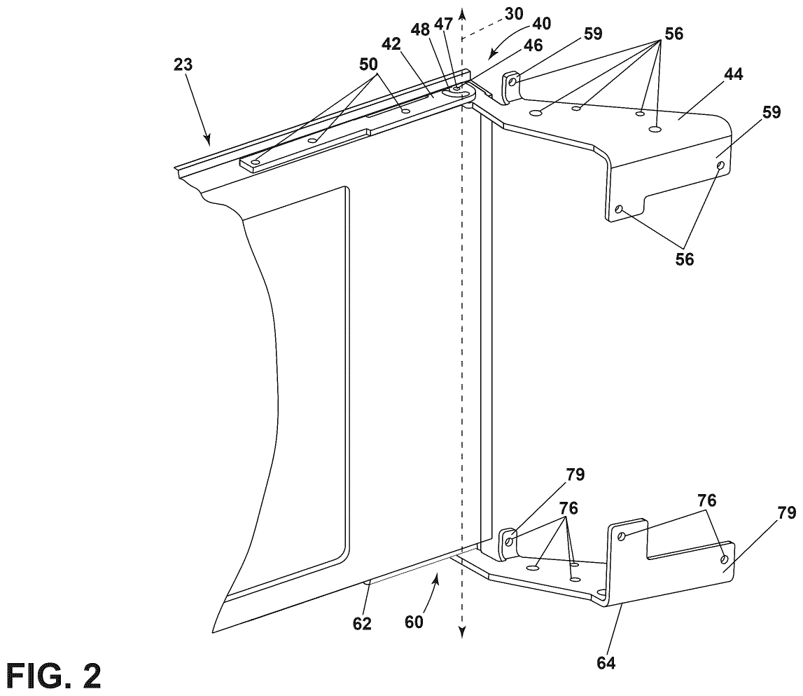

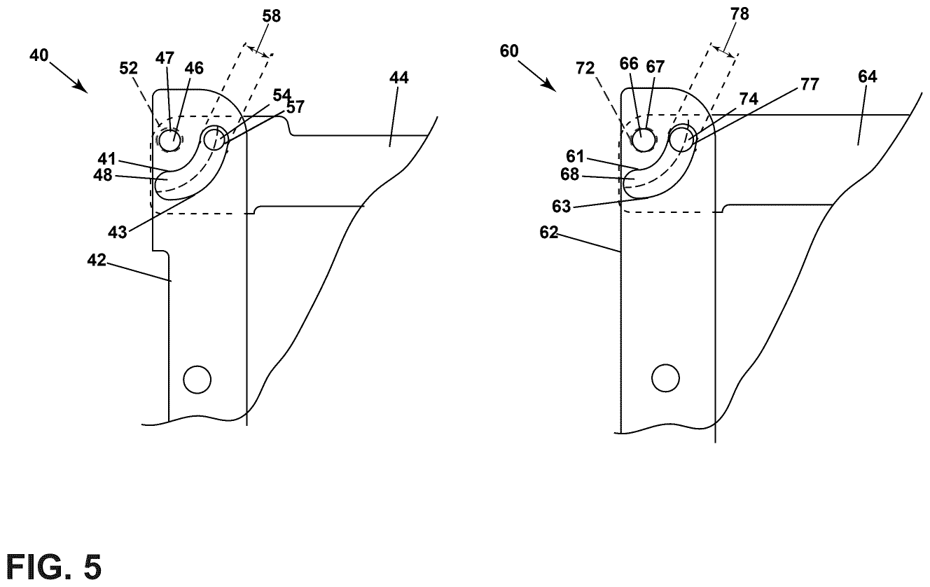

FIG. 2 is a perspective view of the door 23 removed from the chassis 12 (FIG. 1) with the first hinge assembly 40 and the second hinge assembly 60 in the opened position. The first plate 42 of the first hinge assembly 40 includes a first pin 46 defining the vertical axis of rotation 30 and an arcuate aperture 48. As used herein the term “arcuate” is used to describe a shape of an opening, the opening having a curved or arched shape. More specifically, the opening having a centerline, wherein at least 80% of the centerline (FIG. 5) lies on a single circumference of a circle. That is, the radius of curvature of the centerline is constant over at least 80% of the centerline. The first pin 46 can couple to a pin aperture 47 located in the first plate 42 via one or more of a press fit, adhesive, welds, or the like. It is contemplated in a non-limiting example, that the first plate 42 can be a molded part and the first pin 46 can be integrally formed on the first plate 42 as one part. Additionally, the first plate 42 can include at least one mounting aperture, shown as a plurality of mounting apertures 50. The plurality of mounting apertures 50 can receive fasteners (not shown) that couple the first plate 42 to the door 23. The fasteners can include, for example, a screw, a bolt, snap-fit connectors, interference fit connectors, one or more welding points, an adhesive, or any combination thereof.

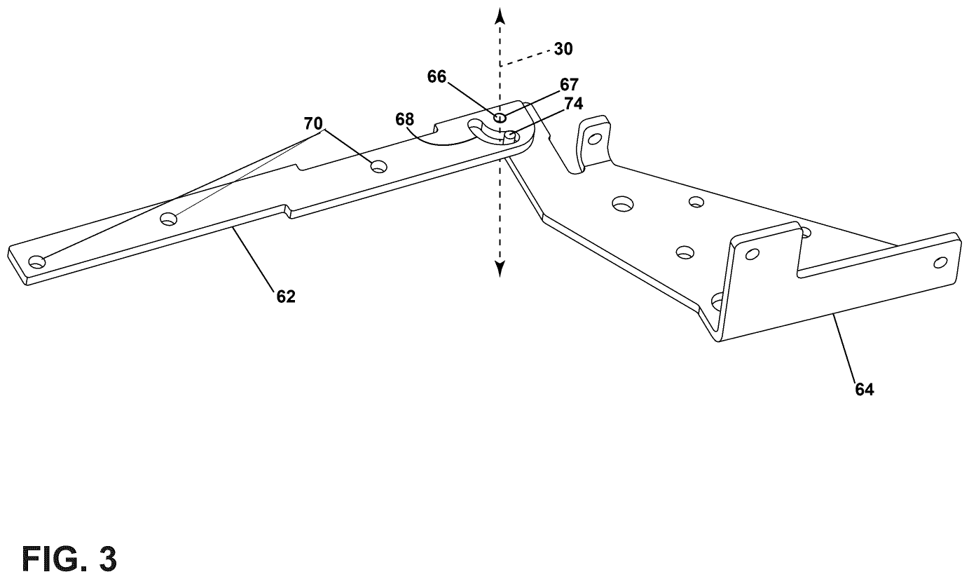

The first pin 46 extending from the first plate 42 is received by a circular aperture of the second plate 44, further discussed in FIG. 3, such that the first plate 42 is moveably coupled to the second plate 44. The first pin 46 moveably couples the first plate 42 to the second plate 44. That is, the second plate 44 receives the first pin 46, connecting the first plate 42 to the second plate 44 such that the door 23 can pivot about the vertical axis of rotation 30.

The second plate 44 can include a mounting aperture, illustrated as a plurality of mounting apertures 56. The plurality of mounting apertures 56 can receive fasteners (not shown) that couple the second plate 44 to the chassis 12 (FIG. 1). The fasteners can include screws, bolts, snap-fit connectors, interference fit connectors, welds, adhesives, or any combination thereof. Additionally, the second plate 44 can include one or more mounting flanges, illustrated as two mounting flanges 59. The mounting flanges 59 can be projections or bends on the second plate 44 that grip the chassis 12 to further secure the second plate 44 in a fixed position. If multiple mounting flanges are included they need not be the same size or configuration.

Similar to the first hinge assembly 40, the first plate 62 of the second hinge assembly 60 can be coupled to the door 23 via one or more fasteners (not shown). The first plate 62 is moveably coupled to the second plate 64 by a first pin 66 (FIG. 3) such that the door 23 can pivot about the vertical axis of rotation 30. The second plate 64 can include a mounting aperture, illustrated as a plurality of mounting apertures 76. The plurality of mounting apertures 76 can receive fasteners (not shown) that couple the second plate 64 to the chassis 12 (FIG. 1), as illustrated, or, alternatively, to the door 23. Additionally, the second plate 64 can include one or more mounting flanges, illustrated as two mounting flanges 79. The mounting flanges 79 can be projections or bends on the second plate 64 that grip the chassis 12 to further secure the second plate 44 in a fixed position. If multiple mounting flanges are included they need not be the same size or configuration.

FIG. 3 further illustrates the second hinge assembly 60 of FIG. 2 with the door 23 removed. At least one mounting aperture 70 can receive a fastener (not shown) to couple the first plate 62 to the door 23 (FIG. 2). The first plate 62 includes the first pin 66 that extends from the first plate 62 along the vertical axis of rotation 30. The first pin 66 can couple to a pin aperture 67 via one or more of a press fit, adhesive, welds, or the like. It is contemplated in a non-limiting example, that the first plate 62 can be a molded part and the first pin 66 can be integrally formed on the first plate 62 as one part. The first pin 66 extending from the first plate 62 is received by the second plate 64 such that the first plate 62 is moveably coupled to the second plate 64. That is, the first plate 62 couples to the second plate 64 via the first pin 66 such that the door 23 (FIG. 2) can pivot about the vertical axis of rotation 30.

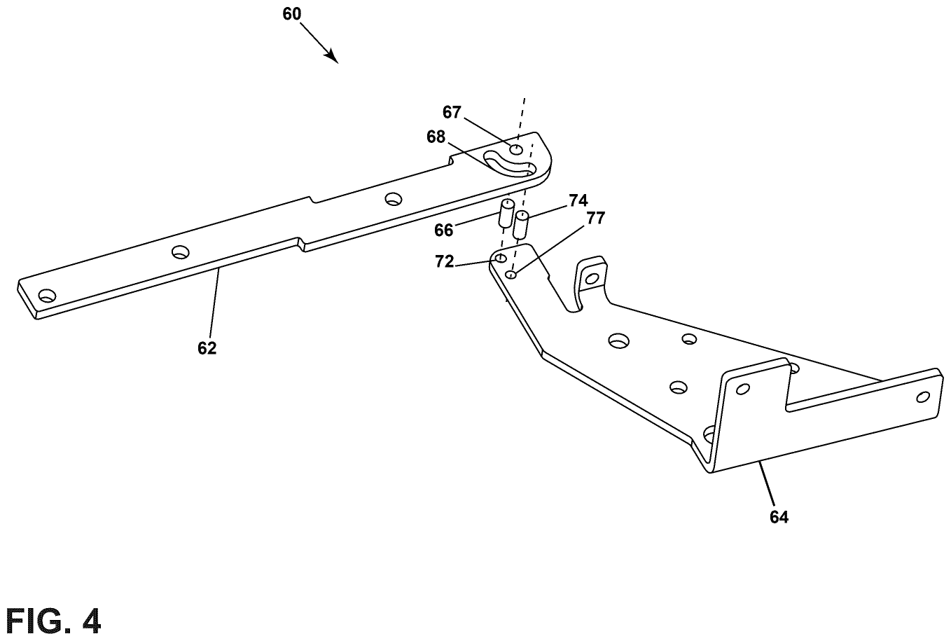

An arcuate aperture 68 is located in the first plate 62. The arcuate aperture 68 receives a second pin 74, which extends from the second plate 64, as further discussed in FIG. 4.

FIG. 4 is an exploded view of the second hinge assembly 60 of FIG. 3 further illustrating the second plate 64. The second plate 64 includes a circular aperture 72 and a pin aperture 77. The pin aperture 77 couples to a second pin 74 via one or more of a press fit, adhesive, welds, or the like, such that the second pin 74 is fixed in the pin aperture 77. It is contemplated in a non-limiting example, that the second plate 64 can be a molded part and the second pin 74 can be integrally formed on the second plate 64 as one part.

The circular aperture 72 is spaced from the second pin 74 such that the circular aperture 72 can receive the first pin 66 of the first plate 62. The second pin 74 can be received by the arcuate aperture 68. It is contemplated that the first pin 66 and the second pin 74 are substantially circular. As used herein the term “substantially circular” is used to describe an outer edge of an object, wherein at least 80% of the outer edge of the object lies along a circumference of a circle. The second pin 74 received by the arcuate aperture 68 is configured for movement along at least a portion of a length of the arcuate aperture 68 during pivotable motion between the opened position and the closed position.

FIG. 5 is an enlarged top perspective view of a portion of the first hinge assembly 40 and a portion of the second hinge assembly 60. The arcuate aperture 48 has a substantially constant radius of curvature and is spaced from the first pin 46. As used herein the term “substantially constant radius of curvature” is used to describe a curved portion of an object, wherein at least 80% of the curved portion of the object lies along the same circle. Additionally, the arcuate aperture 48 has an inner edge 41 and an outer edge 43, where the inner edge 41 has a consistent distance from the first pin 46. Further, the arcuate aperture 48 has a width 58. The width 58 is defined as the distance between the inner edge 41 and an outer edge 43. In a non-limiting example, the width 58 can be within a range from 4.0 millimeters to 4.5 millimeters (mm), inclusive of endpoints. Additionally, the width 58 is variable by up to 1 millimeter (mm) along a length of the arcuate aperture 48. In another non-limiting example, the width 58 is variable by up to 0.5 mm along a length of the arcuate aperture 48. That is, variable in the context of width 58 can be defined as the width 58 being non-constant along at least a portion of the length of the arcuate aperture 48. In the non-limiting example shown, the width 58 is smaller at the center or bisect of the arcuate aperture 48 than at the endpoints of the length of the arcuate aperture. The width 58 being varied across at least a portion of the length of the arcuate aperture 48 provides for a precise movement of the second pin 54 when opening or closing the first hinge assembly 40.

Similar to the second plate 64 of the second hinge assembly 60, the second plate 44 of the first hinge assembly 40 includes a circular aperture 52 and a pin aperture 57. A second pin 54 can be coupled to or otherwise mounted to the pin aperture 57 via one or more of a press fit, adhesive, welds, or the like, such that the second pin 54 is fixed in the pin aperture 57. It is contemplated in a non-limiting example, that the second plate 44 can be a molded part and the second pin 54 can be integrally formed on the second plate 44 as one part. The circular aperture 52 is spaced from the second pin 54 such that the circular aperture 52 can receive the first pin 46 of the first plate 62, and the second pin 54 can be received by the arcuate aperture 48. Further, the second pin 54 received by the arcuate aperture 48 is configured for movement along at least a portion of a length of the arcuate aperture 48 during pivotable motion between the opened position and the closed position.

The arcuate aperture 68 of the second hinge assembly 60 has a substantially constant radius of curvature and is spaced from the first pin 66. Additionally, the arcuate aperture 68 has an edge 61 and an outer edge 63, where the edge 61 has a consistent distance from the first pin 66 across the length of the arcuate aperture. Further, the arcuate aperture 68 has a width 78. The width 78 is defined as the distance between the edge 61 and an outer edge 63. In a non-limiting example, the width 78 of the arcuate aperture 68 can be within a range from 3.2 mm to 3.7 mm, inclusive of endpoints. The width 78 of the arcuate aperture 68 can be varied along at least a portion of the length of the arcuate aperture 68. That is, the width 78 of the arcuate aperture 68 can be non-constant along at least a portion of the length of the arcuate aperture 68. In the non-limiting example shown, the width 78 of the arcuate aperture 68 is larger at the center or bisect of the arcuate aperture 68 than at the endpoints of the length of the arcuate aperture 68. The width 78 of the arcuate aperture 68 being varied along at least a portion of the length of the arcuate aperture 68 provides for a precise movement of the second pin 74 when opening or closing the second hinge assembly 60. That is, the width 78 being larger at the center of the arcuate aperture 68 than at the endpoints of the length of the arcuate aperture 68 helps to facilitate the movement of the second pin 74 along the length of the arcuate aperture 68, whereas the smaller width 78 at the endpoints of the length of the arcuate aperture 68 give stability to the door 23 (FIG. 1) when fully open or closed. To that end, when comparing the first hinge assembly 40 to the second hinge assembly 60, the width 58 is larger than the width 78 and the second pin 54 is larger than the second pin 74.

Referring to FIGS. 1-5, to assemble the first hinge assembly 40 and the second hinge assembly 60 on the microwave oven 10, the first plate 42 of the first hinge assembly 40 and the first plate 62 of the second hinge assembly 60 are mounted to the door 23, where the first plate 42 of the first hinge assembly 40 and the first plate 62 of the second hinge assembly 60 are fastened by bolts or screws (not shown) to the door 23 via the mounting apertures 50 and the mounting apertures 70. Then, the second plate 44 of the first hinge assembly 40 and the second plate 64 of the second hinge assembly 60 are mounted to the chassis 12, where the second plate 44 and the second plate 64 are fastened by bolts or screws (not shown) to the chassis 12 via the plurality of mounting apertures 56 and mounting apertures 76. Then, the first plate 42 of the first hinge assembly 40 is mounted to the second plate 44. In other words, the first pin 46 of the first plate 42 is received by the circular aperture 52 of the second plate 44 and the second pin 54 of the second plate 44 is received by the arcuate aperture 48 of the first plate 42. In addition, the first plate 62 of the second hinge assembly 60 is mounted to the second plate 64. In other words, the first pin 66 of the first plate 62 is received by the circular aperture 72 of the second plate 64 and the second pin 74 of the second plate 64 is received by the arcuate aperture 68 of the first plate 62.

Once mounted, the door 23 with the first plate 42 of the first hinge assembly 40 and the first plate 62 of the second hinge assembly 60 can pivot about the vertical axis of rotation 30, via the first pin 46 of the first hinge assembly 40 and the first pin 66 of the second hinge assembly 60, while the second plate 44 of the first hinge assembly 40 and the second plate 64 of the second hinge assembly 60 remain stationary with the chassis 12. Further, the second pin 54 of the first plate 42 and the second pin 74 of the first plate 62 can move along a portion of the length of the arcuate aperture 48 of the first plate 44 of the first hinge assembly 40 and the arcuate aperture 68 of the first plate 62 of the second hinge assembly 60 during the opening and closing process. The substantially constant radius of curvature of the arcuate aperture 48 of the first hinge assembly 40 and the arcuate aperture 68 of the second hinge assembly 60 allow the second pin 54 of the second plate 44 and the second pin 74 of the second plate 64 to move along at least a portion of the length of the arcuate aperture 48 of the first plate 42 and the arcuate aperture 68 of the first plate 62 in order to facilitate a smoother opening and closing of the door 23. To that end, the width 58 of the arcuate aperture 48 of the first plate 42 and the width 78 of the arcuate aperture 68 of the first plate 62 which can be varied across the length of the arcuate aperture 48 of the first plate 42 and the arcuate aperture 68 of the first plate 62 provide for a precise movement of the second pin 54 of the second plate 44 and the second pin 74 of the second plate 64 when opening or closing the door 23. Once the door 23 is closed, the microwave oven 10 can perform a cycle of operation of cooking.

Aspects of the disclosure provide for several benefits. The varied width of the arcuate aperture across the length of the arcuate aperture provides for a precise movement of the second pin when opening or closing the door. That is, the width at the center of the arcuate aperture being larger than the width at the endpoints of the arcuate aperture helps to facilitate the movement of the door. Further, the smaller width of the endpoints of the arcuate aperture give stability to the door when the door is fully opened or closed. In addition, the constant radius of curvature of the arcuate aperture provides a smoother movement of the second pin of the second plate within the arcuate aperture. This results in an improved quality and user experience as compared to previous assemblies. More specifically, the movement created is smooth through the pivoting of the door between opened and closed positions.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Moreover, while “a set of” or “a plurality of” various elements have been described, it will be understood that “a set” or “a plurality” can include any number of the respective elements, including only one element. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the disclosure are provided by the following clauses:

A household appliance comprising: a chassis having an access opening; a treating chamber accessible via the access opening; a closure element selectively moveable to close the access opening; and at least one hinge assembly moveably coupling the closure element to the chassis for pivotable motion between an opened position and a closed position where the closure element closes the access opening, the at least one hinge assembly comprising: a first plate mounted to one of the chassis or the closure element, the first plate comprising a first pin and an arcuate aperture spaced from and having an edge with a consistent distance from the first pin; a second plate mounted to the other chassis or the closure element, the second plate having a circular aperture configured to receive the first pin such that the first pin defines an axis of rotation for the at least one hinge assembly, the second plate having a second pin configured to be received within the arcuate aperture and configured for movement along at least a portion of the length of the arcuate aperture during pivotable motion between the opened position and the closed position.

The household appliance of any preceding clause, wherein the household appliance comprises a cooking appliance wherein the treating chamber is a cooking chamber.

The household appliance of any preceding clause, wherein the cooking appliance comprises an oven including at least one heating element operably coupled with the cooking chamber.

The household appliance of any preceding clause, wherein the cooking appliance further comprises a microwave generator for providing microwave radiation to the cooking chamber.

The household appliance of any preceding clause, wherein the closure element comprises a door.

The household appliance of any preceding clause, wherein the door pivots about a vertical axis of rotation.

The household appliance of any preceding clause, wherein the at least one hinge assembly comprises a first hinge assembly and a second hinge assembly spaced along a length of the closure assembly.

The household appliance of any preceding clause, wherein a width of the arcuate aperture of the first hinge assembly is larger than a width of the arcuate aperture of the second hinge assembly.

The household appliance of any preceding clause, wherein the width of the arcuate aperture of the first hinge assembly ranges from 4.0 millimeters to 4.5 millimeters, inclusive of endpoints and the width of the arcuate aperture of the second hinge assembly ranges from 3.2 millimeters to 3.7 millimeters inclusive of endpoints.

The household appliance of any preceding clause, wherein a second pin received within the arcuate aperture of the first hinge assembly is larger than the second pin received within the arcuate aperture of the second hinge assembly.

The household appliance of any preceding clause, wherein the width of the arcuate aperture of the first hinge assembly is variable by up to 1 millimeter.

The household appliance of any preceding clause, wherein the width of the arcuate aperture of the first hinge assembly is variable by up to 0.5 millimeters.

The household appliance of any preceding clause, wherein the household appliance is configured for built-in installation.

The household appliance of any preceding clause, wherein the arcuate aperture has a substantially constant radius of curvature.

A household appliance comprising: a chassis having an access opening; a treating chamber accessible via the access opening; a closure element selectively moveable to close the access opening; and at least one hinge assembly moveably coupling the closure element to the chassis for pivotable motion between an opened position and a closed position where the closure element closes the access opening, the at least one hinge assembly comprising: a first plate mounted to one of the chassis or the closure element, the first plate comprising a first pin and an arcuate aperture having a substantially constant radius of curvature; a second plate mounted to the other chassis or the closure element, the second plate having a circular aperture configured to receive the first pin such that the first pin defines an axis of rotation for the at least one hinge assembly, the second plate having a second pin configured to be received within the arcuate aperture and configured for movement along at least a portion of the length of the arcuate aperture during pivotable motion between the opened position and the closed position.

The household appliance of any preceding clause, wherein the at least one hinge assembly comprises a first hinge assembly and a second hinge assembly spaced along a length of the closure assembly.

The household appliance of any preceding clause, wherein a width of the arcuate aperture of the first hinge assembly is larger than a width of the arcuate aperture of the second hinge assembly.

The household appliance of any preceding clause, wherein the width of the arcuate aperture of the first hinge assembly is variable by up to 1 millimeter.

The household appliance of any preceding clause, wherein the width of the arcuate aperture of the first hinge assembly is variable by up to 0.5 millimeters.

The household appliance of any preceding clause, wherein the first pin and second pin are substantially circular.

1. A household appliance comprising:
a chassis having an access opening;
a treating chamber accessible via the access opening;
a closure element selectively moveable to close the access opening; and
at least one hinge assembly moveably coupling the closure element to the chassis for pivotable motion between an opened position and a closed position where the closure element closes the access opening, the at least one hinge assembly comprising:
a first plate mounted to one of the chassis or the closure element, the first plate comprising a first pin and an arcuate aperture spaced from and having an edge with a consistent distance from the first pin, the arcuate aperture having a width and a length, wherein the width is smaller at a center of the arcuate aperture than at endpoints of the length of the arcuate aperture; and
a second plate mounted to the other of the chassis or the closure element, the second plate having a circular aperture configured to receive the first pin such that the first pin defines an axis of rotation for the at least one hinge assembly, the second plate having a second pin configured to be received within the arcuate aperture and configured for movement along at least a portion of a length of the arcuate aperture during the pivotable motion between the opened position and the closed position.

2. The household appliance of claim 1, wherein the household appliance comprises a cooking appliance wherein the treating chamber is a cooking chamber.

3. The household appliance of claim 2, wherein the cooking appliance comprises an oven including at least one heating element operably coupled with the cooking chamber.

4. The household appliance of claim 2, wherein the cooking appliance further comprises a microwave generator for providing microwave radiation to the cooking chamber.

5. The household appliance of claim 1, wherein the closure element comprises a door.

6. The household appliance of claim 5, wherein the door pivots about a vertical axis of rotation.

7. The household appliance of claim 1, wherein the at least one hinge assembly comprises a first hinge assembly and a second hinge assembly spaced along a length of the closure element.

8. The household appliance of claim 7, wherein a width of the arcuate aperture of the first hinge assembly is larger than a width of the arcuate aperture of the second hinge assembly.

9. The household appliance of claim 8, wherein the width of the arcuate aperture of the first hinge assembly ranges from 4.0 millimeters to 4.5 millimeters, inclusive of endpoints and the width of the arcuate aperture of the second hinge assembly ranges from 3.2 millimeters to 3.7 millimeters inclusive of endpoints.

10. The household appliance of claim 8, wherein the second pin received within the arcuate aperture of the first hinge assembly is larger than the second pin received within the arcuate aperture of the second hinge assembly.

11. The household appliance of claim 7, wherein a width of the arcuate aperture of the first hinge assembly is variable by up to 1 millimeter.

12. The household appliance of claim 11, wherein the width of the arcuate aperture of the first hinge assembly is variable by up to 0.5 millimeters.

13. The household appliance of claim 1, wherein the household appliance is configured for built-in installation.

14. The household appliance of claim 1, wherein the arcuate aperture has a substantially constant radius of curvature.

15. A household appliance comprising:
a chassis having an access opening;
a treating chamber accessible via the access opening;
a closure element selectively moveable to close the access opening; and
at least one hinge assembly moveably coupling the closure element to the chassis for pivotable motion between an opened position and a closed position where the closure element closes the access opening, the at least one hinge assembly comprising:
a first plate fixedly mounted to one of the chassis or the closure element, the first plate comprising a first pin and an arcuate aperture having a substantially constant radius of curvature; and
a second plate fixedly mounted to the other of the chassis or the closure element, the second plate having a circular aperture configured to receive the first pin such that the first pin defines an axis of rotation for the at least one hinge assembly, the second plate having a second pin configured to be received within the arcuate aperture and configured for movement along at least a portion of a length of the arcuate aperture during the pivotable motion between the opened position and the closed position;
wherein the closure element is configured to pivot about the axis of rotation via the first pin.

16. The household appliance of claim 15, wherein the at least one hinge assembly comprises a first hinge assembly and a second hinge assembly spaced along a length of the closure element.

17. The household appliance of claim 16, wherein a width of the arcuate aperture of the first hinge assembly is larger than a width of the arcuate aperture of the second hinge assembly.

18. The household appliance of claim 17, wherein the width of the arcuate aperture of the first hinge assembly is variable by up to 1 millimeter.

19. The household appliance of claim 18, wherein the width of the arcuate aperture of the first hinge assembly is variable by up to 0.5 millimeters.

20. The household appliance of claim 15, wherein the first pin and the second pin are substantially circular.
